(19) United States
(12) Patent Application Publication
(10) Pub. No.: US 2023/0134506 A1
(43) Pub. Date: May 4, 2023

(54) SYSTEM AND METHOD FOR MANAGING VM IMAGES FOR HIGH-PERFORMANCE VIRTUAL DESKTOP SERVICES

(71) Applicant: ELECTRONICS AND TELECOMMUNICATIONS RESEARCH INSTITUTE, Daejeon (KR)

(72) Inventors: Won Young KIM, Daejeon (KR); Seong Woon KIM, Daejeon (KR); Seong Hee LEE, Daejeon (KR); Min Ho BAE, Daejeon (KR); Ji Hyeok CHOI, Daejeon (KR)

(73) Assignee: ELECTRONICS AND TELECOMMUNICATIONS RESEARCH INSTITUTE, Daejeon (KR)

(21) Appl. No.: 17/976,279

(22) Filed: Oct. 28, 2022

(30) Foreign Application Priority Data
Oct. 29, 2021 (KR) 10-2021-0147085

(51) Int. Cl. G06F 9/455; G06F 9/451

(52) U.S. Cl. CPC G06F 9/45558; G06F 9/452; G06F 2009/45583

(57) ABSTRACT

The virtual machine (VM) image management method of providing high-performance virtual desktop services includes receiving a request for a VM execution from a client corresponding to a user, building a logical VM image from the user VM disk image in response to the request, and providing a VM driven on the basis of the logical VM image to the client.

### CROSS-REFERENCE TO RELATED APPLICATION

This application claims priority to and the benefit of Korean Patent Application No. 10-2021-0147085, filed on Oct. 29, 2021, the disclosure of which is incorporated herein by reference in its entirety.

### BACKGROUND

### 1. Field of the Invention

The present invention relates to a system and method for managing virtual machine (VM) images for high-performance virtual desktop services.

### 2. Discussion of Related Art

As people enter the non-face-to-face society in the Coronavirus era, generally, a virtual desktop service method of accessing a desktop running on a remote server has been adopted rather than a method of directly accessing physical desktop computing system.

A virtual machine (VM) is a virtual environment that functions as a virtual computer system with its own CPU, memory, network interface, and storage, created on a physical hardware system. A virtual desktop service system creates a VM on which an operating system (OS) and application programs are installed and serves to a user in the form of a desktop interface through a dedicated client program in client's computer.

A VM image is an image file on which an OS and application programs are installed in a virtual machine. We can create a new VM using a VM image stored in a disk. In this case, in the present invention, a VM image stored in a disk will be referred to as a VM disk image.

One virtual desktop server may run from as few as one to as many as several tens of virtual desktops at the same time. When multiple users attempt to boot their virtual desktops at the same time as in a boot storm, the demand for reading their OS in each VM image rises sharply, thus lowering the performance of the entire system. In particular, the disk is significantly slower than other resources (e.g., a main memory) of the server and thus performance degradation may be more serious.

In addition, since the virtual machine disk image is generally a large file, it requires a lot of network and storage resources to move and store between servers.

According to the analysis, VM disk images used by members of the same group contain the same OS and the same application programs.

Therefore, in order to increase the performance of the system and manage resources efficiently, we need a virtual desktop technique that shares the common file blocks between VM images, keeps only non-redundant VM image file blocks for the VM images. Through this, the size of VM disk images can be reduced and the VM disk image can be managed more flexibly.

### SUMMARY OF THE INVENTION

The present invention provides a system and method of virtual machine (VM) image management for high-performance virtual desktop services, which are capable of sharing common blocks between VM images and managing only the updated VM image part for each user as a user virtual machine image.

However, aspects of the present invention are not limited thereto and there may be other various aspects.

According to a first aspect of the present invention, a virtual machine (VM) image management method of providing high-performance virtual desktop services includes receiving a request for a VM execution from a client corresponding to a user, building a logical VM image from the user VM disk image in response to the request, and providing a VM driven on the basis of the logical VM image to the client.

According to a second aspect of the present invention, a VM image management system for providing high-performance virtual desktop services includes a communication module configured to receive a request for a VM execution from a client corresponding to a user and provide a VM service in response to the request, a storage device storing a program providing the VM service, and a processor configured to execute the program stored in the storage device. In this case, the processor executes the program to build a logical VM image from the user VM disk image in response to the for the VM execution, and provide a VM driven on the basis of the logical VM image to the client.

Another aspect of the present invention provides a computer program that performs a VM image management method for high-performance virtual desktop services in combination with a computer, which is hardware, and that is stored in a computer-readable storage medium.

Other details of the present invention are provided in the detailed description and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a virtual machine (VM) image management system that provides a high-performance virtual desktop service according to an embodiment of the present invention;

FIG. 2 is a flowchart of a VM image management method according to an embodiment of the present invention;

FIG. 3 is a diagram for describing a general process of generating a user VM disk image;

FIG. 4 is a diagram illustrating VM images stored in a disk area and a main memory area according to an embodiment of the present invention;

FIG. 5 is a diagram illustrating a concept of building a logical VM image for an arbitrary VM according to an embodiment of the present invention;

FIG. 6 is a flowchart of accessing a logical VM image according to an embodiment of the present invention;

FIG. 7 is a flowchart for describing the deployment of a base VM image and a user VM disk image in a system; and

FIG. 8 is a flowchart for describing the deployment of a base VM image and a user VM disk image in a system when a VM execution request is made for the first time.

### DETAILED DESCRIPTION OF EXEMPLARY EMBODIMENTS

Advantages and features of the present invention and methods of achieving them will be apparent from embodiments described in detail, in conjunction with the accompanying drawings. However, the present invention is not limited to embodiments set forth herein and may be embodied in many different forms. The embodiments are merely provided so that this disclosure will be thorough and complete and will fully convey the scope of the disclosure to those of ordinary skill in the art. The present invention should be defined by the claims.

Terms used herein are for the purpose of describing embodiments only and are not intended to be limiting of the present invention. As used herein, singular forms are intended to include plural forms unless the context clearly indicates otherwise. As used herein, the terms “comprise” and/or “comprising” specify the presence of stated components but do not preclude the presence or addition of one or more other components. Throughout the disclosure, like reference numerals refer to like elements, and “and/or” includes each and all combinations of one or more of the mentioned components. Although “first,” “second,” etc. are used to describe various components, these components are not limited by these terms. These terms are only used to distinguish one component from another. Therefore, a first component mentioned below could be termed a second component without departing from the technical scope of the present invention.

Unless otherwise defined, all terms (including technical and scientific terms) used herein have the same meaning as commonly understood by one of ordinary skill in the art to the present invention pertains. Terms, such as those defined in commonly used dictionaries, will not be interpreted in an idealized or overly formal sense unless expressly so defined herein.

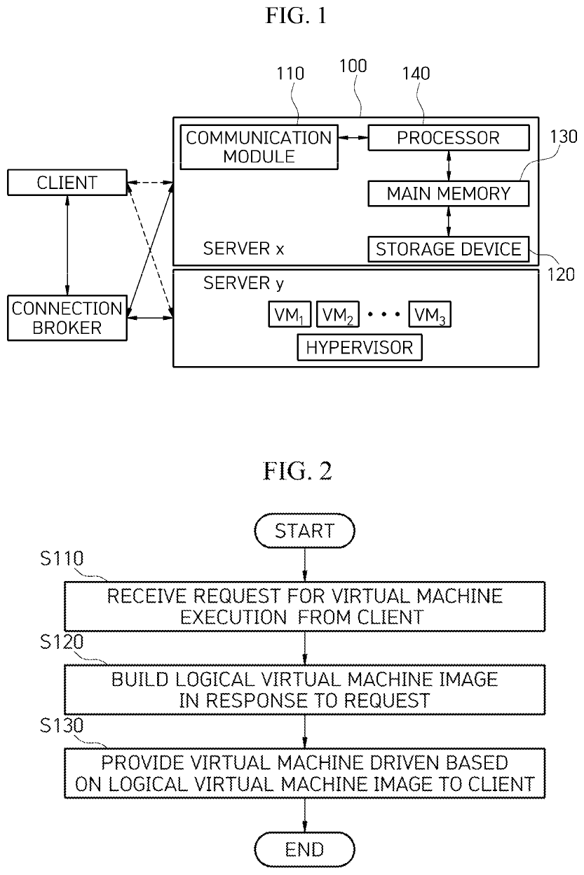

FIG. 1 is a diagram for describing a virtual machine (VM) image management system 100 that provides a high-performance virtual desktop service according to an embodiment of the present invention.

The VM image management system 100 (servers x and y in FIG. 1) includes a communication module 110, a storage device 120, a main memory 130, and a processor 140.

The communication module 110 receives a request for a VM execution from a user and provides a VM service in response to the request.

In FIG. 1, the user transmits the request and executes a service through a client terminal. And the client is connected to a server running a VM through a connection broker. The client drives a VM based on the VM disk image (a user VM disk image) stored in the storage device 120. As a result of the driving, the client is provided with a virtual desktop.

A program for providing a VM service is stored in the storage device 120. And the processor 140 executes the program stored in the storage device 120. Here, the storage device 120 is a nonvolatile storage device in which stored information is retained even when power is not supplied.

Examples of the storage device 120 may include a NAND flash memory such as a compact flash (CF) card, a secure digital (SD) card, a memory stick, a solid-state drive (SSD), and a micro SD card, a magnetic computer storage device such as a hard disk drive (HDD), an optical disc drive such as a CD-ROM and a DVD-ROM, and the like.

A base VM image is loaded on the main memory 130 by the processor 140.

The processor 140 receives a service request from the client. The processor 140 loads a base VM image corresponding to a user VM disk image onto the main memory 130 in response thereto. That is, the processor 140 does not load the base VM image on a general disk.

In addition, the processor 140 stores a logical image area in the user VM disk image stored in a disk. The logical image area is updated as each user uses the VM.

The VM driven based on two images, i.e., a base VM image and a user VM disk image that are built as described above, is provided to the client.

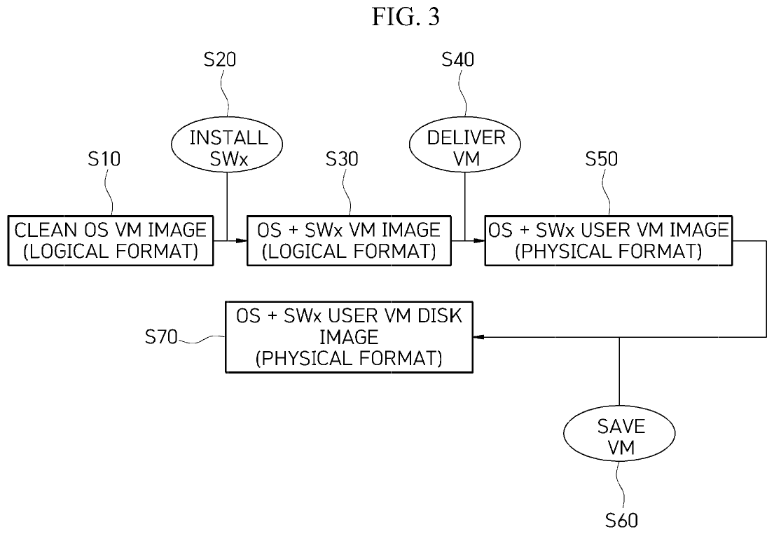

A method performed by the VM image management system 100 that provides a high-performance virtual desktop service according to an embodiment of the present invention will be described with reference to FIGS. 2 to 8 below.

FIG. 2 is a flowchart of a VM image management method according to an embodiment of the present invention.

In the VM image management method according to the embodiment of the present invention, first, a request for a VM execution is received from a client corresponding to a user (S110).

Next, a logical virtual machine image is built from a user VM disk image in response to a request from the user (S120). And next, a VM driven based on the logical VM image is provided to the client (S130).

FIG. 3 is a diagram for describing a general process of generating a user VM disk image.

First, a VM image on which only an OS is installed is prepared (S10). Then, the desired application programs are installed on the VM image (S20). As a result, a VM image (OS+SWx VM image) is builted (S30).

Thereafter, the virtual machine image is distributed to clients (S40). Accordingly, VM images (OS+SWx user VM image) are built for each client (or for each user) (S50).

Next, the VM image is stored in a physical disk and used for a desktop service while the VM is operating (S60). And when the service is terminated, the VM image is stored in the form of a VM disk image. (S70).

A general system does not separately manage the common parts of a VM image. The user VM image S50 that is used during operation and a user VM disk image S70 are the same except for compression.

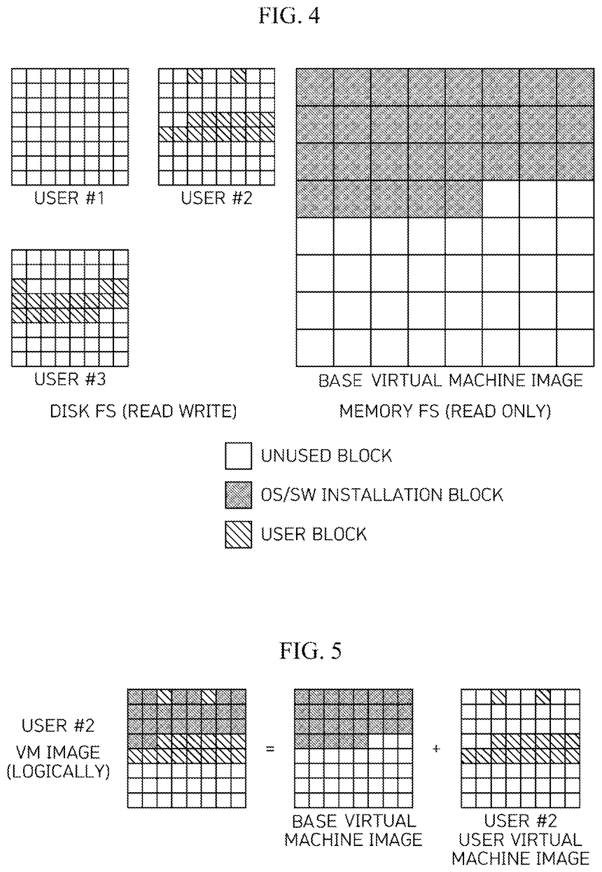

FIG. 4 is a diagram illustrating VM images stored in a disk area and a main memory area according to an embodiment of the present invention.

According to an embodiment of the present invention, a VM image S30 in which an OS and application programs that generate the largest amount of input/output data are installed, to provide a fast VM for a large scale virtual desktop service, is managed as a base VM image. The base VM image is used by being loaded on the main memory 130.

In addition, image areas identified for each client (or for each user) and updated by a user during the execution are stored in the form of a user VM disk image on the storage device 120, i.e., a disk.

As described above, according to an embodiment of the present invention, an OS and application programs to be used commonly by a large number of users may be managed in the form of a base VM image. The base VM image is loaded on the main memory 130 to use the OS and the application program commonly. In addition, the areas updated for each user is composed of a user VM disk image. The user VM disk image is stored in a disk. As a result, it is possible to reduce the sizes of actual VM images being operated. Therefore, VM images can be managed more flexibly. In addition, the performance of the entire system can be improved.

In other words, each user VM disk image has a structure excluding a common base VM image and includes a large number of unused blocks and thus the size of each user VM image when stored in a compressed form may be much less than the compressed size of a VM image of the related art including a base VM image.

FIG. 5 is a diagram illustrating a concept of building a logical VM image for an arbitrary VM according to an embodiment of the present invention.

FIG. 5 shows a logical VM image that user #2 actually accesses in the structure of FIG. 4. The logical VM image of the user #2 is a result of overwriting a user VM disk image on a base VM image.

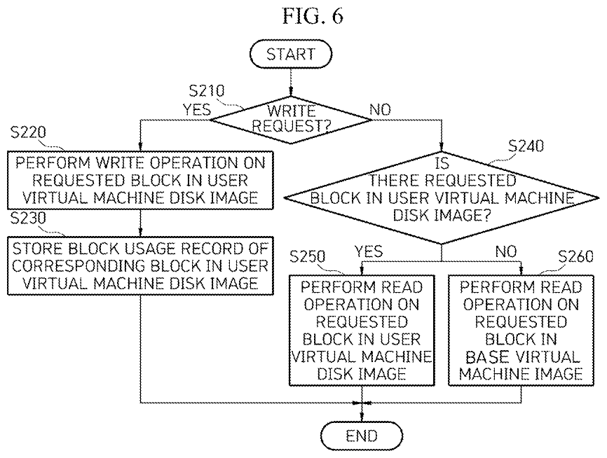

FIG. 6 is a flowchart of accessing a logical VM image according to an embodiment of the present invention.

First, when disk input/output occurs in a kernel of a client's VM, whether the disk input/output is a write request or a read request is determined (S210).

As a result of checking, if the disk input/output is the write request, a write operation is performed on a requested block in a user VM disk image (S220). And it stores the block usage record for the corresponding block in the user VM disk image (S230).

When it is determined that the disk input/output is the read request, whether there is a block corresponding to the read request in the user VM disk image is checked (S240).

When a result of the checking reveals that there is a block corresponding to the read request, a read operation is performed on a requested block in the user VM disk image (S250).

In contrast, when the result of the checking reveals that there is no block corresponding to the read request, the read operation is performed on the requested block in a base VM image loaded on the main memory 130 (S260).

In this case, the user VM disk image is read, disk input/output occurs. But when the base VM image is read, the read operation is performed on a block by accessing the main memory 130 and thus disk input/output does not occur.

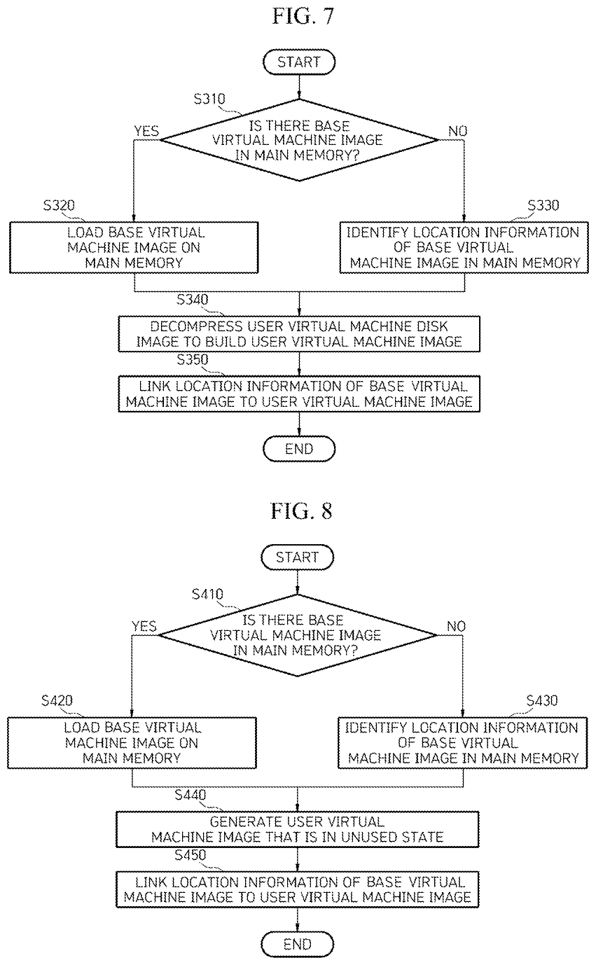

FIG. 7 is a flowchart for describing the deployment of a base VM image and a user VM disk image in a system 100.

Whether a base VM image corresponding to a user VM disk image to be serviced is currently stored in the main memory 130 is checked (S310).

When a result of the checking reveals that the base VM image is not stored in the main memory 130, it is necessary to load the base VM image on the main memory 130 (S320). In contrast, when the base VM image is stored in the main memory 130, location information of the base VM image on the main memory 130 is identified (S330).

Next, the user VM disk image is decompressed to build a user VM image (S340). Then, the location information of the base VM image is linked to and recorded on the user VM image (S350).

FIG. 8 is a flowchart for describing the deployment of a base VM image and a user VM disk image 100 in a system when a VM execution request is made for the first time.

First, whether the base VM image is stored in the main memory 130 is checked (S410).

When a result of the checking reveals that the base VM image is not stored in the main memory 130, it is necessary to load the base VM image on the main memory 130 (S420). In contrast, when the base VM image is stored in the main memory 130, location information of the base VM image on the main memory 130 is identified (S430).

Next, an empty user VM image is generated (S440). That is, the user VM image is specified as an unused state.

Thereafter, the location information of the base VM image is linked to and recorded on the user VM image (S450).

Meanwhile, in the above description, operations S110 to S450 may be divided into additional operations or combined into fewer operations according to an embodiment of the present invention. In addition, some operations may be omitted as needed or an order in which the operations are performed may be changed. Meanwhile, the above description with reference to FIGS. 2 to 8 may also be applied to the above description of the VM image management system 100 of FIG. 1.

The VM image management method of providing a high-performance virtual desktop service according to an embodiment of the present invention as described above may be implemented as a program (or an application) and stored in a medium, so that the VM image management method may be performed by being combined with a computer which is hardware.

The program described above may include code written in a computer language such as C, C++, JAVA, Ruby and machine language, which is readable by a processor (CPU) of a computer through a device interface of the computer, so that the above-described method implemented as the program may be executed by the computer by reading the program. The code may include functional code related to functions that define functions necessary to perform the methods, and control code related to an execution procedure necessary for the processor of the computer to perform the functions according to the execution procedure. The code may further include additional information necessary for the processor of the computer to execute the functions or memory-reference-related code indicating a location (address) in the computer or on an external memory to be referenced by media. When there is a need for the processor of the computer to communicate with another computer or a server at a remote place so as to execute the functions, the code may further include communication-related code indicating how to communicate with another computer or a server at a remote place using a communication module of the computer, what information or media to be transmitted or received during communication, and the like.

The storage medium refers to a medium that stores data semi-permanently and is readable by devices, not a medium that stores data for a short time such as a register, a cache, or a memory. Specifically, examples of the storage medium include a ROM, a RAM, a CD-ROM, a magnetic tape, a floppy disk, an optical data storage device, etc. but are not limited thereto. That is, the program may be stored in various types of recording media on various types of servers accessible by the computer or various types of recording media on the computer of a user. In addition, the media may be distributed to computer systems connected via a network, and computer-readable code may be stored in a distributed method.

According to an embodiment of the present invention described above, in configuration the user's VM image, the user block is separated from the OS and the application programs installation block. The separated user block and the OS and the application programs installation block are loaded onto disk and main memory, respectively. The OS and application programs installation block on the main memory are commonly used by a plurality of VMs. Accordingly, it is possible to reduce the input/output time for code of the OS and application software. In addition, the performance of the overall desktop service can be improved.

In particular, in the case of a boot storm in which multiple desktop VMs using the same application programs are run simultaneously, a response time when a VM is running can be decreased. And it is possible to maximize the throughput of the entire system.

Furthermore, the user VM disk image has empty OS and application programs installation part. Therefore, it can be managed in a relatively small size during migration or storage. As a result, more flexible VM disk image file management is possible.

Effects of the present invention are not limited thereto and other effects not mentioned herein will be apparent to those of ordinary skill in the art from the detailed description.

The above description of the present invention is only intended for the purpose of illustration, and it will be understood by those of ordinary skill in the art that the present invention may be easily embodied in different forms without departing from the technical idea or essential features of the present invention. Therefore, it should be understood that the embodiments set forth herein are merely illustrative in all respects and not restrictive. For example, each component described as a single type may be implemented in a distributed manner, and components described as being distributed may be implemented in a combined form.

The scope of the present invention should be defined by the following claims other than the detailed description, and all changes or modifications derivable from the claims and their equivalents should be construed as being included in the scope of the present invention.

What is claimed is:

1. A virtual machine (VM) image management method of providing high-performance virtual desktop services, which is performed by a computer, the method comprising:
receiving a request for a VM execution from a client corresponding to a user;
building a logical VM image from the user VM disk image in response to the request; and
providing a VM driven on the basis of the logical VM image to the client.

2. The VM image management method of claim 1, wherein the building of the logical VM image from the user VM disk image in response to the request comprises building the logical VM image by overwriting the user VM disk image on the base VM image, wherein the base VM image has an operating system and application programs installed originally.

3. The VM image management method of claim 2, wherein the building of the logical VM image from the user VM disk image in response to the request comprises:
loading a base VM image corresponding to the user VM disk image on a main memory;
generating an empty image on a disk when there is no user VM disk image; and
generating a link between the user VM disk image and the base VM image on the main memory.

4. The VM image management method of claim 1, wherein, when a disk input/output in a kernel of a user's VM is a write request, the building of the logical VM image from the user VM disk image in response to the request comprises:
performing a write operation on a requested block in the user VM disk image; and
storing a block usage record for the block in the user VM disk image.

5. The VM image management method of claim 1, wherein, when a disk input/output in a kernel of a user's VM is a read request, the building of the logical VM image from the user VM disk image in response to the read request comprises:
checking whether there is a block corresponding to the read request in the user VM disk image; and
when there is the block corresponding to the read request, performing a read operation on a requested block in the user VM disk image.

6. The VM image management method of claim 5, wherein, when a result of the checking reveals that there is no block corresponding to the read request, the building of the logical VM image from the user VM disk image in response to the request comprises performing a read operation on the requested block in the base VM image loaded on the main memory.

7. The VM image management method of claim 2, wherein the providing of the VM driven on the basis of the logical VM image to the client comprises:
decompressing the user VM disk image to build a user VM image; and
linking location information of the base VM image to the user VM image.

8. The VM image management method of claim 7, wherein the providing of the VM driven on the basis of the logical VM image to the client comprises:
checking whether the base VM image corresponding to a user VM disk image built for a service of the VM is stored in the main memory; and
when a result of the checking reveals that there is no base VM image, loading the base VM image on the main memory.

9. The VM image management method of claim 2, wherein, when the request for the VM execution is made for a first time, the providing of the VM driven on the basis of the logical VM image to the client comprises designating the user VM image as an unused state and linking location information of the base VM image to the user VM image.

10. A virtual machine (VM) image management system for providing high-performance virtual desktop services, comprising:
a communication module configured to receive a request for a VM execution from a client corresponding to a user and provide a VM service in response to the request;
a storage device storing a program providing the VM service;
a processor configured to execute the program stored in the storage device; and
a main memory in which a base VM image built by the processor is loaded,
wherein the processor executes the program to build a logical VM image from the user VM disk image in response to the for the VM execution, and provide a VM driven on the basis of the logical VM image to the client.

11. The VM image management system of claim 10, wherein the processor builds the logical VM image by overwriting the user VM disk image on the base VM image, wherein the base VM image has an operating system and application programs installed originally.

12. The VM image management system of claim 11, wherein the processor to load a base VM image on the main memory, generate an empty image on a disk when there is no user VM disk image, generate a link between the user VM disk image and the base VM image on the main memory to build a logical VM image.

13. The VM image management system of claim 10, wherein, when a disk input/output in a kernel of a user's VM is a write request, the processor performs a write operation on a requested block in the user VM disk image and stores a block usage record for the block in the user VM disk image.

14. The VM image management system of claim 10, wherein, when a disk input/output in a kernel of a user's VM is a read request, the processor checks whether there is a block corresponding to the read request in the user VM disk image and performs a read operation on a requested block in the user VM disk image when there is the block.

15. The VM image management system of claim 14, wherein, when a result of the checking reveals that there is no block, the processor performs the read operation on the requested block in the base VM image loaded on the main memory.

16. The VM image management system of claim 10, wherein the processor checks whether the base VM image corresponding to the user VM disk image is present on the main memory, and loads the base VM image on the main memory, decompresses the user VM disk image to build the user VM image, and links location information of the base VM image to the user VM image, when a result of the checking reveals that there is no base VM image.

17. The VM image management system of claim 10, wherein, when the request for the VM execution from the user is made for a first time, the processor designates the user VM image as an unused state and links location information of the base VM image to the user VM image.
